(19) United States
(12) Patent Application Publication
(10) Pub. No.: US 2002/0078262 A1
(43) Pub. Date: Jun. 20, 2002

(54) System and methods for providing compatibility across multiple versions of a software system

(75) Inventors: Benjamin R. Harrison, Somerville, MA (US); Daniel S. Nussbaum, Cambridge, MA (US); David A. Kranz, Arlington, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Curl Corporation, Cambridge, MA (US)

(21) Appl. No.: 09/736,949

(22) Filed: Dec. 14, 2000

(51) Int. Cl. G06F 9/00; G06F 9/44; G06F 17/00

(52) U.S. Cl. 709/331; 717/170

(57) ABSTRACT

A system and methods that provide compatibility across multiple versions of a software system, such as an execution engine or run-time system, are disclosed. The software system is structured so that it includes a master module, and one or more helper modules, each helper module being capable of processing applets (i.e., programs or content) that require a particular version of the software system. Each time an applet is to be processed by the software system, the master module determines which helper module should be used to process the applet, and starts the selected helper module if necessary. Compatibility with additional versions can be provided by providing additional helper modules. Because numerous helper modules may be executed simultaneously, applets that require different versions of the software system may be processed simultaneously.

### BACKGROUND OF THE INVENTION

Software updates are a frequent occurrence, often providing benefits such as additional features, bug fixes, and improved performance. Unfortunately, updates and new versions of software can also cause problems with compatibility, particularly when the software being updated is an operating system, run-time system, execution engine, core component library, or any other software system that is relied upon by numerous other pieces of software. Even a minor incompatibility in such a software system can cause many other pieces of software that rely on the system to fail.

Although maintaining complete backwards compatibility in software such as operating systems, run-time systems, execution engines, or core component libraries is desirable, so that software written to execute with previous versions of these systems will continue to function, it is often difficult and costly to maintain complete compatibility. As technology advances, it becomes increasingly difficult to provide the features and performance that the market demands while maintaining compatibility with software designs that may be several years old. Software designers are often faced with the choice of maintaining compatibility with their old designs, while losing the ability to compete with new features and designs, or keeping up with the market by updating their software in incompatible ways, which risks upsetting customers who may have a considerable investment in software that relies on the old designs.

These problems may become even more acute as a result of the ability to download software over a public access network such as the Internet, and the ability of software to automatically update itself over the Internet. For example, a user may have an original application that relies on version 1.0 of a run-time system to execute. The user may later download a new application that relies on version 2.0 of the run-time system, which is not completely compatible with version 1.0. When the new application is executed, the system may automatically download version 2.0 of the run-time system, replacing version 1.0, so that the new application can be executed. When the user attempts to run the original application, it may no longer work, since the version of the run-time system on which it relied has been replaced by a newer version. Since the update happened automatically, the user may not understand why the original application no longer functions, and may not be able to convert back to version 1.0 of the run-time system in order to run the original application.

Maintaining compatibility between versions of a software system becomes increasingly critical for software systems that process content over the Internet. This is because the amount of content that would need to be rewritten if an incompatible change were made may be immense. Rather than having to update tens or hundreds of applications, it may become necessary to update millions of pieces of content. For example, if systems that process HTML (HyperText Markup Language), the language in which most of the content on the World Wide Web is encoded, were updated in a manner such that old content could not be displayed, it would be necessary to update millions of Web pages. Similar difficulties may eventually affect client-side programming language technologies, such as Java® or the Curl™ content language, which is described in “Curl: A Gentle Slope Language for the Web”, M. Hostetter, D. Kranz, C. Seed, C. Terman, S. Ward, MIT Laboratory for Computer Science World Wide Web Journal, Volume 11. II, Issue 2, Spring 1997, and in co-pending U.S. patent application Ser. No. 09/677,482, filed Sep. 28, 2000, and entitled “INTEGRATED CONTENT LANGUAGE FOR USE ON THE WEB”, which is incorporated herein by reference.

As used herein, the term “applet” describes any code or content which is processed within the context of another software system, and therefore depends on that software system. For example, under this definition, an HTML page that is processed by a Web browser is an applet (the browser is the “software system” on which it depends), as is Curl™ content or a Java® program that is processed by an execution engine or run-time system. Thus, in general, when a software system is changed or updated, certain applets that were capable of being processed by the software system before it was changed or updated may no longer be able to be processed by the software system after it has been changed or updated.

One way in which the problem of maintaining compatibility while permitting needed updates has been addressed is by guaranteeing compatibility only for a limited period of time, or across a limited number of versions. This permits updates and changes to be made over time, while maintaining backwards compatibility for a (hopefully) long enough period of time to permit users to migrate to new versions of any software or applet that may fail when the software system is updated in an incompatible way. Unfortunately, it may not be possible to obtain new versions of some software or applets, and the cost of updating a significant collection of software or applets may be prohibitive.

In some cases, it may be possible to keep multiple versions of a system, so that the appropriate version of that system may be used with each applet. This may impose a burden on the user to keep track of the multiple versions of the required software system, and to keep track of which applets rely on which versions of the required software system. Additionally, in some cases, keeping multiple complete versions of a software system in a condition in which they are ready to be immediately or simultaneously executed may be impractical or expensive. For many software systems, such as most operating systems, it may be difficult or impossible to run multiple versions of the system simultaneously, and switching between versions may be difficult or inconvenient.

### SUMMARY OF THE INVENTION

In view of the above, it would be desirable to provide a system and methods that permit simultaneous execution of multiple applets that rely on multiple incompatible versions of a software system.

It would further be desirable to provide a system and methods that permit a software system to maintain compatibility with applets that rely on the software system, without limiting any updates or changes that may be made to the software system.

An upgradeable software system comprises a master module and one or more helper modules, wherein each helper module is capable of processing applets that depend on a version of the software system. It should be noted that the helper modules may also be referred to as slave modules. The master module determines which version of the software system is needed to process an applet, and uses an appropriate helper module to process the applet. The master module and helper modules communicate using a protocol for which backward compatibility is maintained, to insure that when the software system is updated (i.e. by providing an updated master module, a new helper module, or both), the master module in the updated software system is still capable of communicating with each of the helper modules.

In a particular embodiment, these methods are used to provide compatibility across multiple versions of an execution engine that executes applets that use a browser for their display. In accordance with the present invention, the execution engine comprises a master module, which serves as a dispatcher for helper modules, and that routes communications between the browser and the helper modules.

In a particular embodiment, the execution engine determines which helper module should be used to process a given applet by examining a “herald” that appears at the beginning of each applet. The herald contains a list of all of the versions of the execution engine under which the applet can be processed. A helper module that is compatible with the applet is selected from among the available helper modules, and is launched (if necessary) and used to process the applet.

### BRIEF DESCRIPTION OF THE DRAWINGS

The foregoing and other objects, features and advantages of the invention will be apparent from the following more particular description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram showing the software environment in which a particular embodiment of the present invention is used;

FIGS. 2A-2B are diagrams demonstrating the problem with updating a software system;

FIGS. 3A-3C are diagrams showing the structure and use of a software system in accordance with the present invention;

FIG. 4 shows the structure of a software system in accordance with the present invention, in which modules of the software system are executed as threads within multiple host processes;

FIG. 5 is a flowchart of a method in accordance with the present invention for dispatching a helper module to process an applet;

FIG. 6 is a diagram showing the structure of an applet in accordance with a particular embodiment of the present invention; and

FIG. 7 shows the components of a computer system suitable for use with the software system and methods of the present invention.

### DETAILED DESCRIPTION OF THE INVENTION

A description of preferred embodiments of the invention follows.

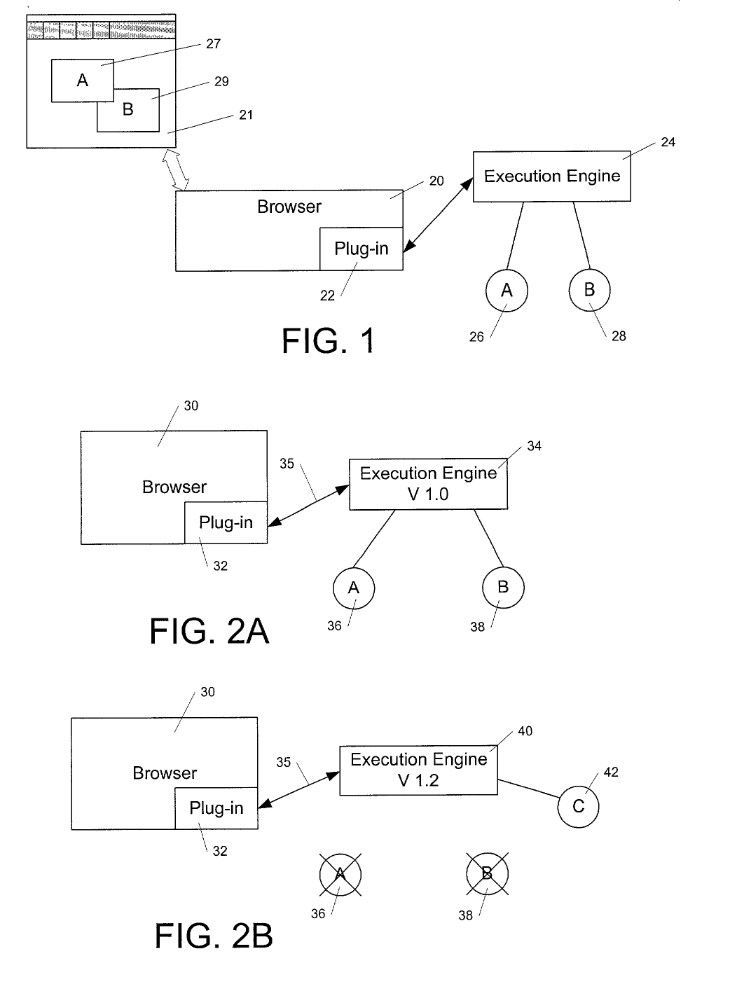

Referring to FIG. 1, an example of an environment in which the system and methods of the present invention may be used is shown. Browser 20 is a program that executes on a computer to display the results of processing an applet. For example, browser 20 may be a standard Web browser that displays text and graphics content written in HTML (HyperText Markup Language) or Curl™, or output from programmed content, written in a language such as Curl™ or Java®. Browser 20 may comprise a standard, commercially available Web browser, such as Internet Explorer, available from Microsoft Corporation of Redmond, Washington, or Netscape Navigator, available from Netscape Communication Corporation, of Mountain View, Calif. Alternatively, browser 20 may comprise a program, such as the Surge Lab™ integrated developer's environment, available from Curl Corporation, of Cambridge, Massachusetts, that is able to communicate with execution engine 24, and display the results of processing one or more applets.

Applets 26 and 28 are programs or content that are processed by execution engine 24, and display their results and interact with users through browser 20. Applets 26 and 28 preferably are handled by execution engine 24 as separate tasks, and are preferably permitted to interact with each other only in a secure manner. In a particular embodiment, applets 26 and 28 are written in the Curl™ content language, and may comprise source code, fully compiled code, and/or partially compiled code, or other content, such as text or graphics.

Applets 26 and 28 control the contents of windows 27 and 29, respectively, which are child windows of main browser window 21 that is controlled by browser 20. It should be noted that an applet can create such a child window that completely fills the display area of the main browser window, allowing that applet to effectively take over the entire display area of the browser.

Browser 20 may require plug-in module 22 to provide for communication between browser 20 and execution engine 24. Plug-in module 22 preferably comprises a plug-in module compatible with a commercial Web browser, such as those mentioned hereinabove. In a particular embodiment for use on computers running the Microsoft Windows operating system, portions of the communication between plug-in module 22 and execution engine 24 may be implemented using COM (Microsoft's Component Object Model), though many other implementations are also possible.

It should be noted that plug-in module 22 may not be needed in browsers that are specifically designed to interact with execution engine 24. Generally, plug-in module 22 is needed to permit standard Web browsers, such as Internet Explorer, or Netscape Navigator, to interact with execution engine 24.

Execution engine 24 is a software system that processes applets that are written in a programming language or content language that can use browser 20 to display results, and to interact with users. Execution engine 24 includes software that executes applets, and also provides a run-time environment and core component libraries for applets that are processed by execution engine 24. Execution engine 24 further provides an interface which permits commands and results to be sent between browser 20 and applets 26 and 28 through execution engine 24.

Preferably, the language executed by execution engine 24 is machine independent, permitting applets written in the language to be processed on any computer that is capable of running execution engine 24. In a preferred embodiment, execution engine 24 processes applets written in the Curl™ content language.

It will be understood that the environment described herein is only one computing environment in which the system and methods of the present invention may be advantageously employed. Although a preferred embodiment applies the system and methods of the present invention to providing compatibility across multiple versions of an execution engine, such as execution engine 24, similar systems and methods may be used to maintain compatibility across multiple versions of other types of software systems, such as run-time environments, libraries, operating systems, or other software systems.

Referring to FIGS. 2A and 2B, difficulties encountered when providing updates for an execution engine or run-time environment are described. Similar to the system described with reference to FIG. 1, in FIG. 2A, browser 30 includes plug-in 32, which communicates with execution engine 34 through interface 35, to process applets 36 and 38. Execution engine 34 is version 1.0 of the execution engine, and applets 36 and 38 are both designed to be processed under version 1.0 of the execution engine.

In FIG. 2B, execution engine 40 is version 1.2 of the execution engine, which is needed to execute applet 42. Unfortunately, applets 36 and 38, which relied on version 1.0 of the execution engine are no longer able to operate under execution engine 40, since version 1.2 of the execution engine is not fully compatible with version 1.0. Thus, a user of this system would no longer be able to process applets 36 or 38 once execution engine 34, which is version 1.0 of the execution engine, is replaced with execution engine 40, which is version 1.2 of the execution engine. Similarly, a system using version 1.0 of the execution engine is unable to process applet 42, which requires version 1.2 of the execution engine.

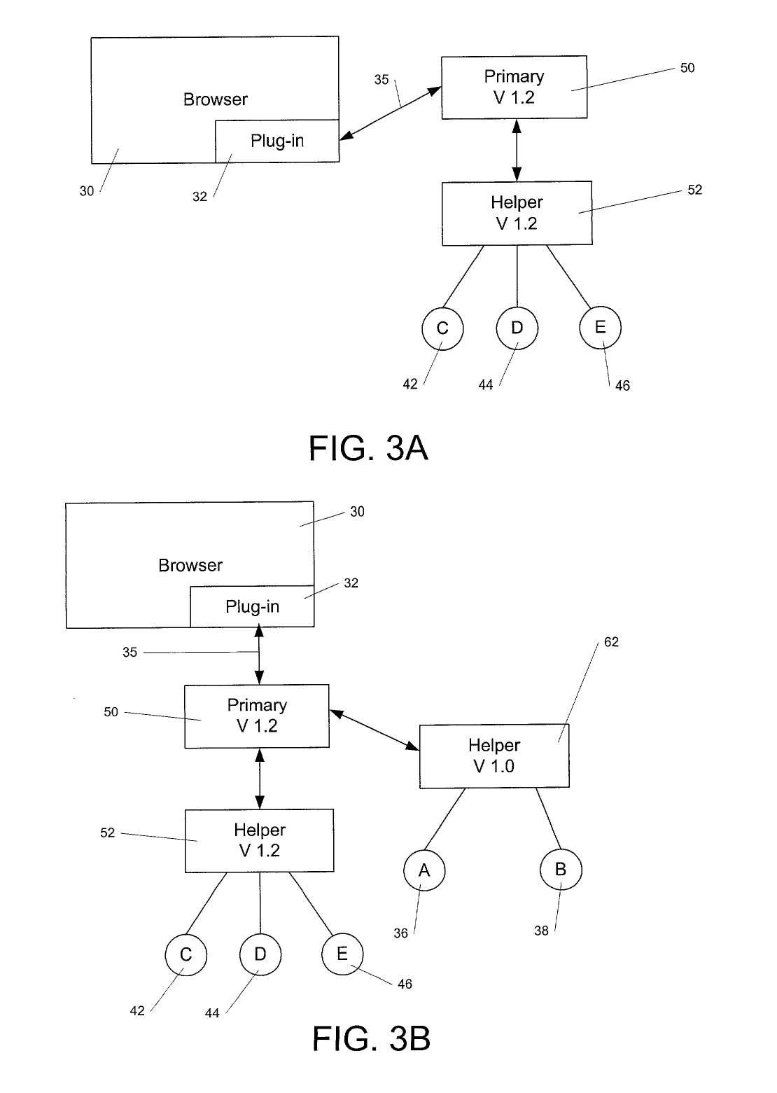

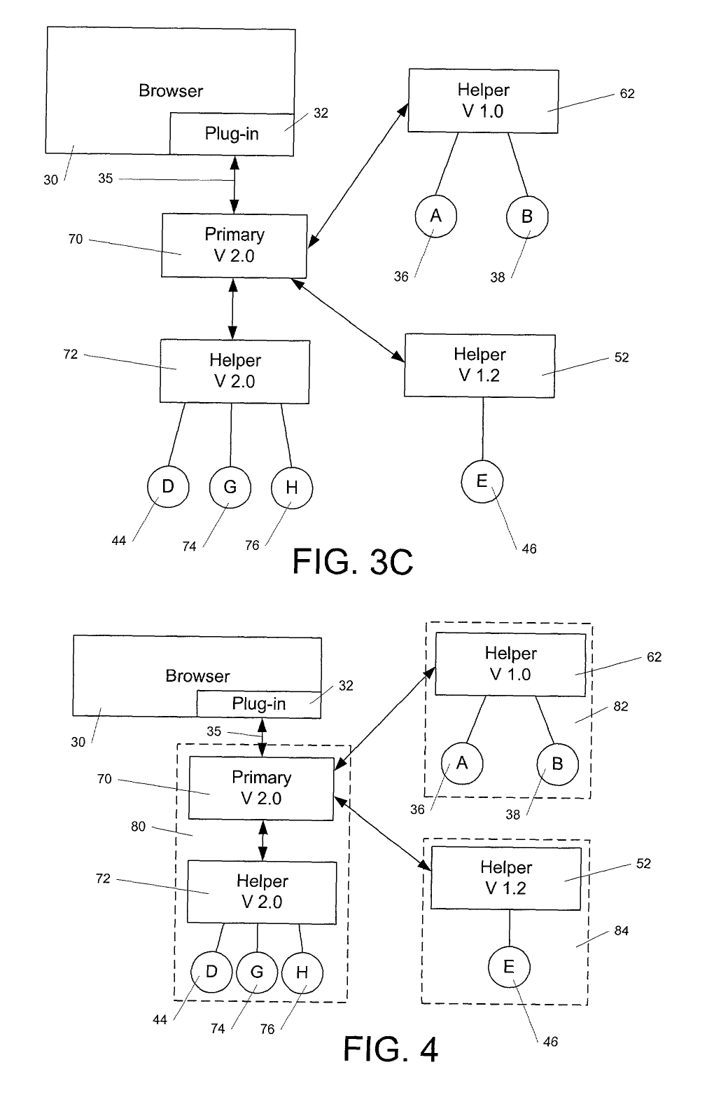

Referring now to FIGS. 3A-3C, a particular embodiment of a system designed in accordance with the principles of the present invention is described. FIG. 3A shows a system running a single version (version 1.2) of the execution engine. In this system, the execution engine has been split into two main parts; master module 50, and helper module 52. Master module 50 communicates with browser 30 and with helper module 52 in a manner so that browser 30 need not be aware of the existence of helper module 52. Helper module 52 processes applets 42, 44, and 46, all of which require version 1.2 of the execution engine. Helper module 52 includes the runtime environment and core libraries for version 1.2 of the execution engine.

Master module 50 communicates with applets 42, 44, and 46 through helper module 52. All communication between master module 50 and helper module 52 uses a defined protocol. As long as this protocol remains backward compatible, master module 50 may communicate with any prior or current version of the helper module, as well as with applets that are processed by these helper modules. It will be understood that backward compatibility may be maintained by having updated versions of the master module support the protocol used to communicate with prior versions of the helper modules. The protocol used to communicate between an updated version of the master module and an updated version of the helper module need not remain the same (or even compatible), as long as the protocols used by previous versions of the helper module continue to be supported by the master module of the execution engine.

In a particular embodiment, master module 50 serves as a “dispatcher”, starting additional helper modules as needed to execute applets. Master module 50 may also perform other services on behalf of browser 30, helper modules, and applets, such as services related to security.

Referring now to FIG. 3B, the system described with reference to FIG. 3A is shown with the addition of helper module 62. Helper module 62 is a helper module that is capable of processing applets that require version 1.0 of the execution engine, and is therefore capable of processing applets 36 and 38.

Master module 50 and helper module 62 preferably communicate using a protocol that was used to communicate between version 1.0 of the master module and version 1.0 of the helper module (i.e. helper module 60). This protocol need not be compatible with the protocol used to communicate between master module 50 and helper module 52. In a preferred embodiment, communication amongst master module 50, helper module 52, helper module 62, and any applets is achieved using a remote procedure call or remote method invocation mechanism. Interface definitions for handling such communication are shown in Appendix A.

When the execution engine is updated to a new version, the helper module of the current version may be used with the updated execution engine to permit applets that require the current version to be processed. In FIG. 3C, the execution engine has been updated to version 2.0, including updated master module 70 and updated helper module 72. Applet 44 is compatible with version 2.0 of the execution engine, and can therefore be processed directly by updated helper module 72. Applet 74 is a new replacement for applet 42 of FIG. 3B, so there is no longer any need to execute applet 42. Applets 74 and 76 require version 2.0 of the execution engine, and therefore must be processed by updated helper module 72.

To process applets 36 and 38, which require version 1.0 of the execution engine, updated master module 70 communicates with helper module 62, which substantially comprises the helper module portion of version 1.0 of the execution engine. Similarly, to process applet 46, master module 70 communicates with helper module 52, which substantially comprises the helper module of version 1.2 of the execution engine.

Updated master module 70 communicates with each of helper modules 52, 62, and 72 in a manner that is transparent to browser 30, which need not be aware that any helper modules are being used. As before, communication between updated master module 70 and helper module 62 preferably uses a protocol that is compatible with the protocol that was used between version 1.0 of the master module and version 1.0 of the helper module, while communication between updated master module 70 and helper module 52 preferably uses a protocol that is compatible with the protocol used to communicate between version 1.2 of the master module and version 1.2 of the helper module. Communication between updated master module 70 and updated helper module 72 need not be compatible with any previous version. It will be understood that although the protocol used to communicate between an updated master module and an updated helper module may be changed in incompatible ways with each update, it is preferable to seldom make such changes, to keep the number of different communication protocols that must be supported by future versions of the master module to a minimum.

Advantageously, when creating a new version of the execution engine such as version 2.0, little or no additional effort is required for that new version to keep the ability to support applets that require version 1.0 or version 1.2 of the execution engine, since the helper modules for these versions are substantially the same as the helper modules that were provided as part of version 1.0 and version 1.2 of the execution engine. When another new version of the execution engine is released, updated helper module 72 of version 2.0 of the execution engine may be used by the new version as a helper module to allow applets that require version 2.0 of the execution engine to be processed.

It should be noted that by executing certain of the master modules, helper modules, and applets as threads within a single host process, various system resources may be shared between them. For example, in a preferred embodiment, the master module and helper module of the same version of the execution engine may execute within a single host process, along with any applets that are being processed by the helper module. Different versions of the helper module, along with the applets that are processed by them, execute in separate host processes. FIG. 4 shows this configuration, in which master module 70, helper module 72 and applets 44, 74, and 76 all execute within host process 80, while helper module 62 (i.e. version 1.0 of the helper module) and applets 36 and 38 execute within host process 82, and helper module 52 (i.e. version 1.2 of the helper module and applet 56 execute within host process 84.

It will be understood by one skilled in the art that many other configurations of host processes could also be used. For example, master module 70 could be in a separate host process, or helper modules 52 and 62 could be combined into the same host process as master module 70 and helper module 72. In general, any combination in which the master module and the helper modules execute within one or more host processes may be used.

In a preferred embodiment, a command line option or other method of specifying an execution option is used to instruct the execution engine on whether it should run as a master module or as a helper module. For example, if the execution engine is run using the command “execution-engine” with no command line options, it will execute as a master module, starting helper modules as needed to process applets. Using the command line “execution-engine—helper” will cause the execution engine to run as a helper module only. It will be apparent to one skilled in the art that the names of the execution engine and of the command line options that determine the behavior of the execution engine may be changed. It will further be understood that there are many ways in which these options may be specified other than through use of a command line.

Although the helper modules described hereinabove permit applets that require previous versions of the execution engine to be executed, it may be relatively expensive in terms of memory, processing, and other resources to use these helper modules. Thus, their use should be avoided unless they are necessary. Generally, a helper module should only be started if it is necessary to process an applet that cannot be processed under any currently running execution engine or helper module. Helper modules should be shut down as soon as there are no more applets that require them.

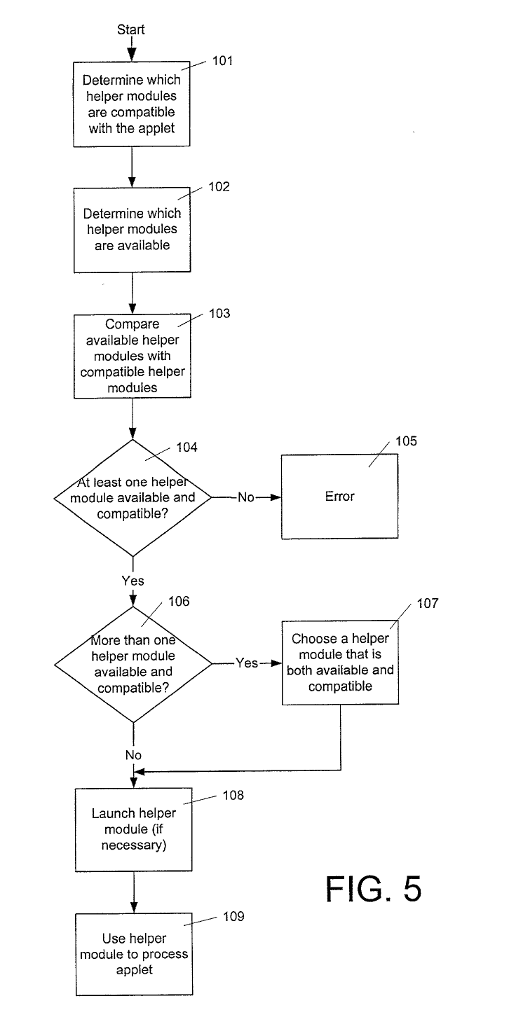

Referring now to FIG. 5, a high-level flowchart of a method for dispatching a helper module to process an applet is described. At step 101, the system determines a set of helper modules that are compatible with an applet that is to be processed. As will be described in greater detail hereinbelow, in a particular embodiment, this step comprises reading a “herald” located at the beginning of the source code of an applet that lists the versions of the helper module with which the applet is compatible. It will be understood that there are other ways of determining compatibility.

At step 102, the system determines a set of helper modules that are available. Availability of a helper module may be determined, for example, by checking to see which helper modules are currently loaded on a disk or other local storage medium that may be read by the computer on which the applet is to be processed. Alternatively, a helper module may be “available” if it can be downloaded across a network, or otherwise acquired when needed. It should be noted that in some embodiments, it is only necessary to check the availability of those helper modules that are determined to be compatible with the applet to be processed.

At step 103, the set of available helper modules is compared with the set of compatible helper modules. If no compatible helper module is available (step 104), then an error occurs, and the applet cannot be processed (step 105).

At step 106, the system determines if there are multiple helper modules that are both available and compatible with the applet that is to be processed. If so, at step 107, the system selects one such helper module to process the applet. There are numerous ways in which a helper module may be selected. For example, in a preferred embodiment of the present invention, the most recent version of the helper module that is both available and compatible with the applet is chosen. Alternatively, the system may choose a compatible helper module that is already executing, in order to avoid having to launch a new helper module. In general, factors such as the costs involved in making a helper module available (e.g., if it needs to be downloaded), the costs involved in starting a helper module, the costs involved in running a helper module, as well as other factors may be used to determine which helper module to use.

Once a helper module is chosen, or if there was only one compatible helper module available, at step 108, the helper module may be launched. In a preferred embodiment, if the helper module is already executing (i.e., it has already been launched to process another applet), it is not necessary to launch the helper module, and this step may be skipped. Launching the helper module may require that the chosen helper module be loaded from disk, or, in some embodiments, that it be downloaded across a network if it is not stored on a disk or on another locally accessible storage medium.

Finally, at step 109, the chosen helper module is used to process the applet.

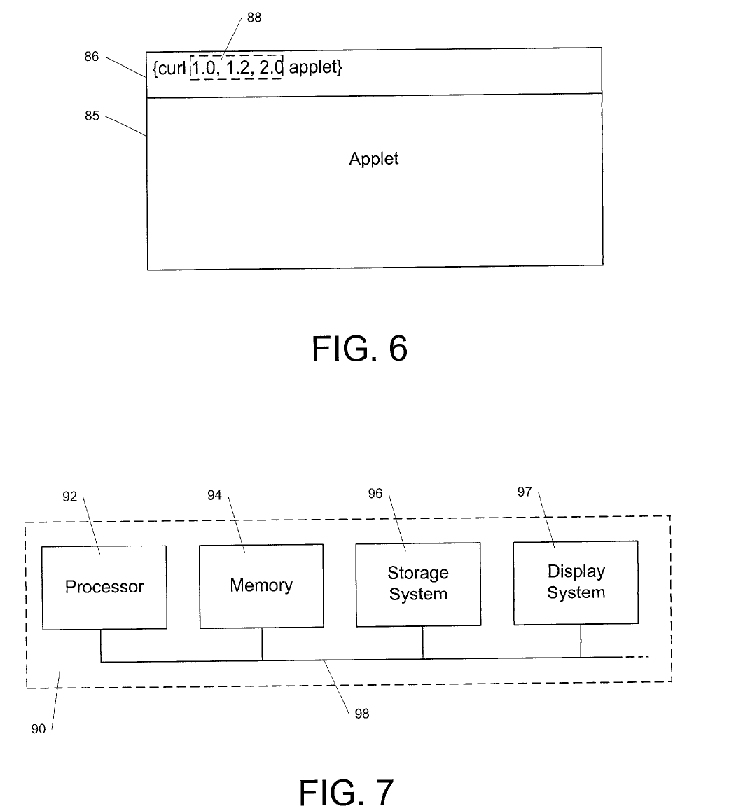

As demonstrated by the method described above with reference to FIG. 5, it is necessary to be able to determine the versions of the helper module with which any given applet is compatible. In a preferred embodiment of the present invention, based on the Curl™ content language, this is done using a “herald” that is placed at the beginning of the source code for each applet, as shown in FIG. 6.

As shown in FIG. 6, applet 85 comprises herald portion 86, placed at the beginning of the source code of applet 85. Herald portion 86 includes list 88 of versions of the execution engine with which applet 85 is compatible. When applet 85 is processed, the master module of the execution engine examines list 88 (either in the source, or in a compiled or partially compiled version of applet 85) to determine which versions of the helper module may be used.

In a preferred embodiment, list 88 contains an entry for each version of the execution engine with which the applet is compatible. This list is prepared by the author of the applet, and could potentially contain inaccuracies, which may cause the applet to fail. In a preferred embodiment, the version numbers in the list match the exact number shown, and any numbers following an additional “.”. For example, the “1.2” entry in the list would match version 1.2, 1.2.1, 1.2.2, and so on. Numbers may also be specified that match a particular patch level or higher. For example, “1.2.4+” would match any of versions 1.2.4, 1.2.5, 1.2.6, and so on, but would not match version 1.2.3.

It will be apparent to one skilled in the art that there is other syntax that could be used to specify the versions of the helper module with which applet 85 is compatible. For example, syntax for specifying ranges of version numbers could be used. Similarly, the structure, syntax, and placement of the herald may all be changed without departing from the invention. One skilled in the art will recognize that such changes may be necessary to make the herald mechanism described herein work with languages and systems other than the Curl™ content language.

Use of a herald construct, such as is described with reference to FIG. 6 is a preferred method of determining the versions of the helper module with which a particular applet is compatible. Other methods may be used without departing from the invention. For example, it may be possible to automatically determine the helper modules with which an applet is compatible by examining the calls that it makes to core library functions, by looking at the date on which it was compiled, or by examining information placed in the applet by a compiler, such as the compiler version used. One skilled in the art will recognize that there are numerous other indicators that may be used to determine the versions of a helper module with which an applet may be compatible.

Although the system and methods described hereinabove are discussed with reference to an execution engine, similar techniques could be used with other software systems. For example, most any run-time system could be structured in accordance with the present invention. Additionally, it may be possible to structure the core components of an operating system so that helper modules could be used to provide a compatible execution environment to software that requires an incompatible version of an operating system.

In general, a master module (or “dispatcher”) may be used to determine the version of the system that is needed by any given applet. If necessary, the master module can launch a helper module to process the applet. As long as the methods of communicating between the master module and the helper modules remain compatible, the helper modules can be used to handle applets that requires incompatible versions of a software system. The method used to determine whether an applet is compatible with any given execution engine will vary according to the type of applet being processed, and according to the nature of the software system with which these methods are used.

Referring now to FIG. 7, a block diagram of a computer system suitable for use with the present invention is described. Computer system 90 includes at least processor 92. for processing information according to programmed instructions, and memory 94, for storing information and instructions for processor 92. Additionally, computer system 90 may optionally include storage system 96, such as a magnetic or optical disk system, for storing instructions and information on a relatively long-term basis. Computer system 90 also may optionally include display system 97, such as a video controller and monitor, on which information may be displayed. Processor 92, memory 94, storage system 96, and display system 97 are coupled to bus 98, which preferably provides a high-speed means for devices connected to bus 98 to communicate with each other.

It will be apparent to one of ordinary skill in the art that computer system 90 is illustrative, and that alternative systems and architectures may be used with the present invention. It will further be understood that many other devices, such as a network interface (not shown), and a variety of other input and output devices (not shown) may be included in computer system 90. Computer system 90 may be a personal computer system, a workstation, a set-top box designed to be connected to a television or other similar display, a hand-held device, such as a cell phone or personal digital assistant, or any other device that contains a processor capable of executing programmed instructions and a memory capable of storing programmed instructions.

Those skilled in the art should readily appreciate that the programs defining the operations and methods defined herein are deliverable to a computer in many forms, including but not limited to a) information permanently stored on nonwriteable storage media such as ROM devices, b) information alterably stored on writeable storage media such as floppy disks, magnetic tapes, CDs, RAM devices, and other magnetic and optical media, or c) information conveyed to a computer through communication media, for example using baseband signaling or broadband signaling techniques, as in an electronic network such as the Internet or telephone modem lines. The operations and methods may be implemented in a software executable out of a memory by a processor or as a set of instructions embedded in a carrier wave. Alternatively, the operations and methods may be embodied in whole or in part using hardware components, such as Application Specific Integrated Circuits (ASICs), state machines, controllers or other hardware components or devices, or a combination of hardware and software components.

While preferred illustrative embodiments of the present invention are described above, it will be evident to one skilled in the art that many changes and modifications may be made without departing from the invention. It is intended in the appended claims to cover all such changes and modifications that fall within the true spirit and scope of the invention.

### APPENDIX A

Curl Interface Between an Applet and Browser

The following list of methods defines an interface between a browser and each of its applets, for use in an execution engine that executes applets written in the Curl™ content language. The master module and the helper modules serve as intermediaries, and use similar interfaces.

Remote Interface to an Applet

create:

Connect the applet to a given host window at the given location, and with a given size.

suspend:

Suspend execution of the applet, disconnecting it from its host window.

resume:

Resume execution of the applet, reconnecting it to a given host window at a given location and with a given size.

kill:

Kills the applet, permanently stopping its execution and recovering any of its resources.

parent:

Re-parents the applet to a new host window and/or relocates/resizes it in its current host window.

set-file-caching-style:

Sets the manner in which file accesses by the applet will be treated by the HTTP caching mechanism.

load-start:

Begin the process of elaborating Curl content by the applet into its host window.

load-append:

Continue the process of elaborating additional Curl content by the applet into its host window. This method is called repeatedly.

load-finish:

Finish the process of elaborating Curl content by the applet into its host window.

get-document-state:

Request from the applet a string representing its state, including such details as the position of scrollbars, which may be used later with set-document-state.

set-document-state:

Request that the applet restore its state to that represented by a string previously obtained from get-document-state.

scroll-to-anchor:

Request that the applet scroll to the given anchor, if possible.

print-embedded:

Tell the applet to perform the necessary operations to print itself.

user-command:

Tell the applet to perform a predefined command such as “cut”, “copy”, “paste”, and “print”.

Remote Interface to a Browser

set-title:

Ask the browser to set its title-bar to display a given string.

set-status:

Ask the browser to set its status-bar to display a given string.

post-url-name:

Ask the browser to perform an HTTP POST operation of some given data to a given url, and load the response into a given target window.

browse-url-name:

Ask the browser to perform an HTTP GET operation of a given url, and load the response into a given target window.

browser-offset:

Ask the browser to move forwards or backwards a given amount in its history list, in a given target window.

loading-info:

Tell the browser about the final result of the process of elaborating Curl content.

handle-keypress:

Tell the browser to handle a given keypress event.

What is claimed is:

1. A method of processing a first applet using a software system, the method comprising:
providing one or more helper modules, each helper module capable of processing an applet that is compatible with that helper module;
providing a master module that is capable of dispatching a helper module;
using the master module to dispatch a first helper module selected from the one or more helper modules, wherein the first helper module is compatible with the first applet; and
using the first helper module to process the first applet.

2. The method of claim 1, further comprising:
providing a second applet to be processed by the software system, wherein the second applet is incompatible with the first helper module;
using the master module to dispatch a second helper module selected from the one or more helper modules, wherein the second helper module is compatible with the second applet; and
using the second helper module to process the second applet.

3. The method of claim 1, wherein using the master module to dispatch a helper module selected from the one or more helper modules comprises:
determining helper modules that are compatible with the applet;
determining helper modules that are available for use; and
selecting a helper module that is both available and compatible with the applet.

4. The method of claim 3, wherein determining helper modules that are compatible with the applet comprises examining a herald associated with the applet, the herald listing helper modules that are compatible with the applet.

5. The method of claim 3, wherein determining helper modules that are available for use comprises determining which helper modules are available on a local storage medium.

6. The method of claim 3, wherein determining helper modules that are available for use comprises determining which helper modules may be downloaded over a network.

7. The method of claim 3, wherein selecting a helper module comprises selecting a helper module that having a most recent version.

8. The method of claim 3, wherein selecting a helper module comprises selecting a currently executing helper module.

9. The method of claim 3, wherein selecting a helper module comprises using one or more criteria selected from a set of criteria consisting of:
costs of making a helper module available;
costs of starting a helper module; and
costs of executing a helper module.

10. The method of claim 1, wherein using the master module to dispatch a first helper module comprises:
determining if the first helper module is currently executing; and
starting the first helper module if the first helper module is not currently executing.

11. The method of claim 1, wherein the software system comprises an execution engine that permits applets to interact with a browser, and wherein using the first helper module to process the first applet comprises communicating between the first applet and the browser.

12. The method of claim 11, wherein communicating between the first applet and the browser comprises sending communications through the master module and the first helper module.

13. A software system that processes a first applet, the software system comprising:
one or more helper modules, each helper module capable of processing applets that are compatible with that helper module; and
a master module that dispatches a first helper module to process the first applet, the master module selecting the first helper module from the one or more helper modules, the first helper module selected to be compatible with the first applet.

14. The software system of claim 13, wherein the software system further processes a second applet which is incompatible with the first helper module, and wherein the master module dispatches a second helper module to process the second applet, the master module selecting the second helper module from the one or more helper modules, the second helper module selected to be compatible with the second applet.

15. The software system of claim 14, wherein the master module communicates with the first applet by communicating with the first helper module using a first protocol, and wherein the master module communicates with the second applet by communicating with the second helper module using a second protocol.

16. The software system of claim 15, further comprising an updated version of the master module, wherein the updated version of the master module communicates with the first applet by communicating with the first helper module using the first protocol, and wherein the updated version of the master module communicates with the second applet by communicating with the second helper module using the second protocol.

17. The software system of claim 13, wherein the first applet comprises a herald section that lists versions of helper modules with which the first applet is compatible.

18. The software system of claim 13, wherein the first applet displays output in a browser, and wherein the browser communicates with the first applet through the master module and the first helper module.

19. The software system of claim 18, further comprising a browser plug-in that provides an interface between the browser and the master module.

20. The software system of claim 13, wherein the software system is an execution engine that executes applets written in a programming language.

21. The software system of claim 20, wherein the software system executes applets written in the Curl content language.

22. A software system capable of processing a first applet that is compatible with a first version of the software system and a second applet that is compatible with a second version of the software system, the software system comprising:
a first helper module that is capable of processing applets that are compatible with the first version of the software system, the first helper module processing the first applet;
a second helper module that is capable of processing applets that are compatible with the second version of the software system, the second helper module processing the second applet;
a master module that provides communication with the first applet by communicating with the first helper module, and that provides communication with the second applet by communicating with the second helper module, the master module further determining when additional helper modules should be started, and determining which helper module will be used to process additional applets.

23. The software system of claim 22, wherein the first applet and the second applet use a browser to display output, and wherein the master module communicates with the browser to provide communications between the browser and the first applet and between the browser and the second applet.

24. The software system of claim 23, further comprising a browser plug-in that provides an interface between the browser and the master module.

25. A computer that uses a software system to process one or more applets, the computer comprising:
a processor that executes programmed instructions; and
a memory that stores a plurality of programmed instructions, including programmed instructions for the software system that, when executed by the processor, cause the computer to:
use a first helper module to process a first applet;
use a second helper module to process a second applet that is not compatible with the first helper module; and
use a master module to communicate with the first applet by communicating with the first helper module and to communicate with the second applet by communicating with the second helper module.

26. The computer of claim 25, wherein the memory further stores programmed instructions that cause the computer to use the master module to start additional helper modules and to determine which helper module will process additional applets.

27. A computer data signal including program code for processing a first applet using a software system comprising:
program code for providing one or more helper modules, each helper module capable of processing an applet that is compatible with that helper module;
program code for providing a master module that is capable of dispatching a helper module;
program code for using the master module to dispatch a first helper module selected from the one or more helper modules, wherein the first helper module is compatible with the first applet; and
program code for using the first helper module to process the first applet.

28. A computer program product including computer program code for processing a first applet using a software system, comprising:
one or more helper modules, each helper module capable of processing an applet that is compatible with that helper module; and
a master module that is capable of dispatching a first helper module selected from the one or more helper modules, wherein the first helper module is compatible with the first applet.

29. A software system that processes a first applet, the software system comprising:
one or more helper module means for processing an applet that is compatible with that helper module means;
a primary module means for dispatching a first helper module selected from the one or more helper module means, wherein the first helper module means is compatible with the first applet.
